(19) United States
(12) Patent Application Publication
(10) Pub. No.: US 2010/0238504 A1
(43) Pub. Date: Sep. 23, 2010

(54) PRINTING SYSTEM

(75) Inventors: Shigenori Kanno, Shiojiri-shi (JP); Moonhe Lee, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/729,181

(22) Filed: Mar. 22, 2010

(30) Foreign Application Priority Data
Mar. 23, 2009 (JP) 2009-070841

(51) Int. Cl. G06F 3/12

(52) U.S. Cl. 358/1.15

(57) ABSTRACT

A printing system includes: a host apparatus; and a printer as a device apparatus which is connected to the host apparatus. The host apparatus includes: a data amount determining unit which determines whether data of a printing target file exceeds a storage capacity of a receiving and storing memory of the printer; a starting command converting unit which converts a file transmission starting command to be transmitted to the printer from a batch transmission starting command to an on-demand transmission starting command when the data of the printing target file exceeds the storage capacity of the receiving and storing memory of the printer; and an on-demand transmission control unit which transmits a sub data file to the printer according to reception of the data requirement from the printer after transmission of the on-demand transmission starting command.

### CROSS REFERENCE TO RELATED APPLICATION

The entire disclosure of Japanese Patent Application No. 2009-070841, filed Mar. 23, 2009 is expressly incorporated by reference herein.

### BACKGROUND

1. Technical Field

The present invention relates to a printer driver which is installed in a host apparatus of a printing system in which data of a printing target file is transmitted from the host apparatus to a printer as a device apparatus and is printed, a printing control program of the printer and the printing system.

2. Related Art

In the related art, there is proposed a technology in which, when image data of a JPEG (Joint Photographic Experts Group) file of a digital camera is printed in a printer, a direct print adapter is installed between the digital camera and the printer, the image data of the JPEG file of the digital camera is converted to printing data for the printer by the direct print adapter, and the printing data is transmitted to the printer and then printed. (For example, refer to Japanese Patent No. 3593820 (paragraphs 0043, 0048, FIG. 1 and FIG. 2, etc.))

Further, there is proposed a technology in which a digital camera and a printer are directly connected to each other, for example, via a USB (Universal Serial Bus) according to the PictBridge standard, a JPEG file of image data as printing target data is transmitted to the printer from the digital camera using the printer as a host apparatus and using the digital camera as a device apparatus, and the received image data is converted into printing data on the printer side and then printed.

Recently, in an information processing apparatus having a computer configuration such as a highly functional home game machine, there is proposed a technology in which the information processing apparatus and a printer are connected each other through a USB cable to form a printing system, image data of a printing target file such as image data of a JPEG file (printing target file) of the information processing apparatus obtained by photography by means of a digital camera or downloading from a website is transmitted from the information processing apparatus to the printer on the basis of a print control by a predetermined command from a printer driver installed in the information processing apparatus and on the basis of a data requirement of the printer using the information processing apparatus as a host apparatus and using the printer as a device apparatus, and the image data of the received printing target file is converted into printing data and printed by the printer.

As described above, in the case of the printing system in which the data of the printing target file such as a JPEG file is transmitted to the printer from the host apparatus such as an information processing apparatus on the basis of the data requirement of the printer as the device apparatus and is printed in the printer, the size of the data of the printing target file which is capable of being transmitted to the printer from the host apparatus is determined by a storage capacity (RAM capacity) of a receiving and storing buffer of the printer. For example, about 3 MB or 5 MB (MB refers to megabyte) is an upper limit of the storage capacity. Thus, the data of the printing target file having a data size exceeding the upper limit cannot be transmitted to the printer for printing.

Further, for example, as resolution of the digital camera becomes high, the data size of the printing target file tends to become large, thereby easily exceeding the upper limit.

For this reason, in the above described printing system, how to print data of a printing target file having the data size exceeding the upper limit is an important issue.

In addition, in order to enable printing of the data of the printing target file having the data size exceeding the upper limit, a method may be considered that a pixel size of the data is reduced or a parameter of a compression ratio is reset to a higher compression ratio so that the data size becomes smaller than the upper limit in the printing target file having a large data size, and the data is transmitted to the printer. However, in this case, since the reduction of the pixel size or the resetting of the compression ratio is unnecessarily performed, printing image quality may be significantly deteriorated. Further, due to the reduction of the pixel size or the resetting of the compression ratio, a large amount of work buffer memory, specifically, for example, a work buffer memory of about 40 MB for image data of an A4 size is required to be provided in the host apparatus, but there is possibility that such a large amount of work buffer memory cannot be provided in the host apparatus.

### SUMMARY

An advantage of some aspects of the invention is that it provides a printing system which is capable of printing even data of a printing target file exceeding an upper limit of an receiving and storing capacity of a printer without reducing a pixel size and without resetting a compression ratio when the data of the printing target file is transmitted to the printer from a host apparatus and is printed on the basis of a data requirement of the printer as a device apparatus.

By a printer driver (program) according to the invention, a computer of the host apparatus serves as a data amount determining unit which determines whether data of a printing target file exceeds a storage capacity of a receiving and storing memory of a printer as a device apparatus which is connected to the host apparatus when data of the printing target file is transmitted to the printer from the host apparatus and is printed on the basis of a data requirement of the printer; a starting command converting unit which converts a file transmission starting command to be transmitted to the printer, from a batch transmission starting command to an on-demand transmission starting command, when the data of the printing target file exceeds a storage capacity of a receiving and storing memory of the printer; and an on-demand transmission control unit which transmits a sub data file, which is formed by dividing the data of the printing target file into data of a printing process unit amount of the printer, to the printer according to reception of the data requirement from the printer after transmission of the on-demand transmission starting command.

In the host apparatus installed with the printer driver having such a configuration according to the invention, if the data of the printing target file which is transmitted to the printer from the host apparatus for printing is larger than the storage capacity of the receiving and storing memory to exceed an upper limit of the receiving and storing capacity of the printer, a file transmission starting command to be transmitted to the printer is converted into the on-demand transmission starting command from the batch transmission starting command by the starting command converting unit on the basis of the determination of the data amount determining unit, and the on-demand transmission starting command is transmitted to the printer. Then, if the data requirement is received from the printer in response to the on-demand transmission starting command, the sub data file formed by dividing the data of the printing target file into the data of the printing process unit amount of the printer is transmitted to the printer by the on-demand transmission control unit.

Thus, when the data of the printing target file having the size of the data exceeding the upper limit of the receiving and storing capacity of the printer is printed, not all the data is transmitted at one time to the printer from the host apparatus for receiving and storing in the printer. Instead, the data file (sub data file) formed by dividing the data of the printing target file into a data size acceptable to a printing process of the printer is sequentially transmitted to the printer from the host apparatus, and transmission/reception and printing of the sub data is repeated by an on-demand process, thereby printing the data of the printing target file. In this case, it is not necessary to reduce a pixel size of the printing target file or to reset a compression ratio in the host apparatus, and thus, a large amount of work buffer memory does not need to be provided in the host apparatus.

In the print control program according to the invention, a computer of a printer which is connected as a device apparatus to a host apparatus installed with a printer driver serves as a data requirement transmission control unit which initially transmits a data requirement to the host apparatus according to reception of an on-demand transmission starting command and transmits a next data requirement every time when data of a sub data file, which is formed by dividing data of a printing target file into data of a printing process unit amount and is transmitted from the host apparatus, is printed; and a printing process control unit which controls a printing process for the data of the received sub data file every time when the sub data file transmitted from the host apparatus is received on the basis of the data requirement.

In the printer installed with a print control program with such a configuration according to the invention, if the on-demand transmission starting command is received from the host apparatus, the data requirement is initially transmitted to the host apparatus by means of the data requirement transmission control unit. Then, every time when the sub data file formed by dividing the data of the printing target file into the data of the printing process unit amount is received from the host apparatus, the data of the received sub data file is print-processed by control of the printing process control unit. Further, the next data requirement is transmitted by the data requirement transmission control unit, and thus, data of the next received sub data file is print-processed in the same way.

Thus, when the data of the printing target file having the size exceeding the upper limit of the receiving and storing capacity of the printer is printed, the data of the sub data file transmitted from the host apparatus on the basis of the data requirement is sequentially printed by the so-called on-demand process, thereby printing the data of the printing target file.

A printing system according to the invention includes: a host apparatus; and a printer as a device apparatus which is connected to the host apparatus, wherein the host apparatus includes: a data amount determining unit which determines whether data of a printing target file exceeds a storage capacity of a receiving and storing memory of the printer when the data of the printing target file is transmitted to the printer and printed on the basis of a data requirement of the printer; a starting command converting unit which converts a file transmission starting command which is transmitted to the printer, from a batch transmission starting command to an on-demand transmission starting command, when the data of the printing target file exceeds the storage capacity of the receiving and storing memory of the printer; and an on-demand transmission control unit which transmits a sub data file, which is formed by dividing the data of the printing target file into data of a printing process unit amount of the printer, to the printer according to reception of the data requirement from the printer after transmission of the on-demand transmission starting command, and wherein the printer includes: a data requirement transmission control unit which initially transmits the data requirement to the host apparatus according to reception of the on-demand transmission starting command and transmits a next data requirement every time when data of the sub data file, which is formed by dividing the data of the printing target file into the data of the printing process unit amount and is transmitted from the host apparatus, is printed; and a printing process control unit which controls a printing process for the data of the received sub data file every time when the sub data file transmitted from the host apparatus is received on the basis of the data requirement.

In the printing system with such a configuration according to the invention, if the data of the printing target file transmitted to the printer from the host apparatus exceeds the storage capacity of the receiving and storing memory of the printer, in the host apparatus, the file transmission starting command to be transmitted to the printer is converted to the on-demand transmission starting command from the batch transmission starting command by the starting command converting unit on the basis of the determination of the data amount determining unit, and then, the on-demand transmission starting command is transmitted to the printer. Further, if the data requirement is received from the printer after transmission of the on-demand transmission starting command, the sub data file formed by dividing the data of the printing target file into the data of the printing process unit amount of the printer is transmitted to the printer by the on-demand transmission control unit. In the printer, if the on-demand transmission starting command is received from the host apparatus, the data requirement is initially transmitted to the host apparatus by the data requirement transmission control unit. Then, every time when the printer receives the sub data file transmitted from the host apparatus on the basis of the data requirement, the data of the received sub data file is print-processed by the printing process control unit of the printer. Every time when the data of the sub data file is printed, the next data requirement is transmitted to the host apparatus by the data requirement transmission control unit, and thus, data of the next received sub data file may be print-processed in the same way.

Thus, when the data of the printing target file having the data size exceeding the upper limit of the receiving and storing capacity of the printer is printed, the data of the sub data file formed by dividing the data of the printing target file transmitted from the host apparatus is sequentially printed on the basis of the data requirement transmitted to the host apparatus from the printer. Thus, the data of the printing target file can be printed by repeating the transmission/reception and printing process of the so-called on-demand sub data, without reduction of a pixel size of the printing target file and resetting of a compression ratio or the like in the host apparatus and without storage of the received data in the printer.

### BRIEF DESCRIPTION OF THE DRAWINGS

The invention will be described with reference to the accompanying drawings, wherein like numbers reference like elements.

FIG. 1 is a block diagram illustrating a printing system according to an embodiment of the invention.

FIG. 2 illustrates a control configuration of a printer in FIG. 1.

FIG. 3 is a flowchart illustrating a process in a host apparatus in FIG. 1.

FIG. 4 is a flowchart illustrating a process in the printer in FIG. 1.

FIG. 5 is a flowchart specifically illustrating a part of the process in the printer in FIG. 1.

FIG. 6 is a flowchart specifically illustrating another part of the process in the printer in FIG. 1.

FIG. 7 is a flowchart specifically illustrating still another part of the process in the printer in FIG. 1.

FIG. 8 is a flowchart illustrating a response process for a data requirement of the printer in FIG. 1.

FIG. 9 is a flowchart illustrating a relation of the processes and communication between the host apparatus and the printer in FIG. 1.

### DESCRIPTION OF EXEMPLARY EMBODIMENTS

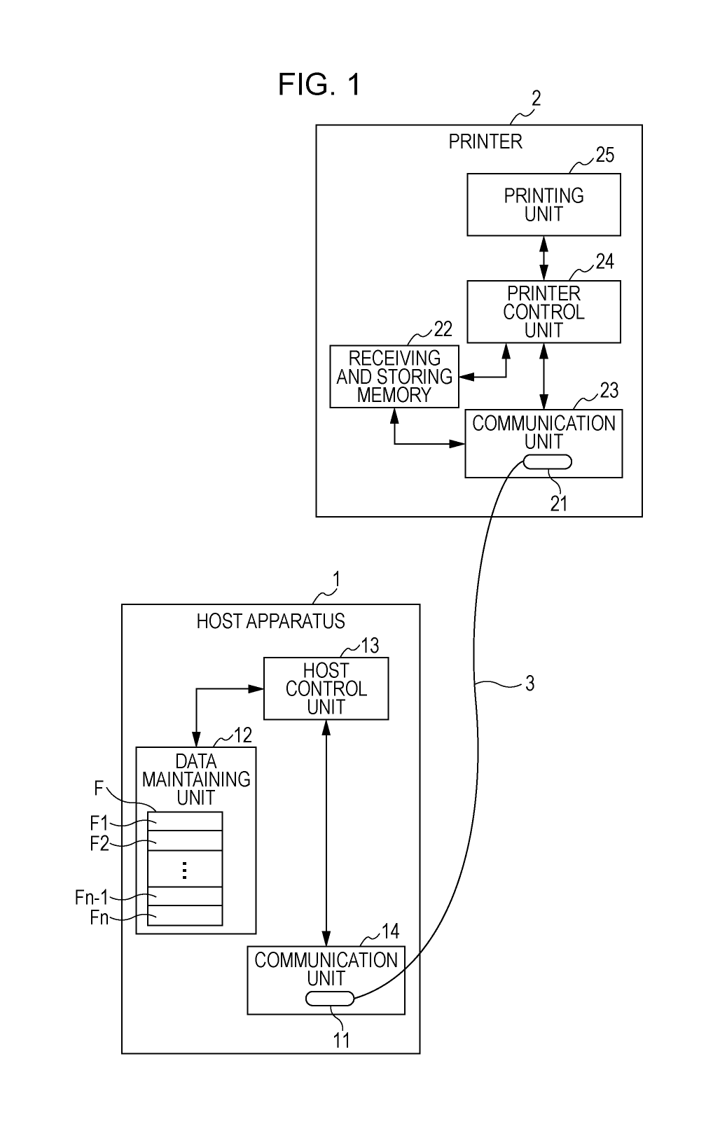

FIG. 1 illustrates a configuration of a printing system according to an embodiment of the invention. A host apparatus 1 is provided as, for example, an information processing apparatus such as a microcomputer device. A printer 2 is provided as, for example, an ink jet printer. A USB terminal 11 of the host apparatus 1 and a USB terminal 21 of the printer 2 are wire-connected to each other via a USB cable 3. In the case of a wireless USB (WUSB), both the USB terminal 11 and the USB terminal 21 are wirelessly connected to each other. In addition, the host apparatus 1 and the printer 2 may be connected to each other according to a communication interface standard other than the USB.

The host apparatus 1 stores one or a plurality of JPEG files F of a photograph image or the like of a digital camera in a data storing unit 12 which is formed by a semi-conductor memory or a hard disc apparatus, and includes a host control unit 13 having a microcomputer configuration, and a communication unit 14 including the USB terminal 11.

The host control unit 13 stores a printer driver (program) according to the invention, which is installed in the host apparatus 1, in a ROM or a RAM (not shown), and the host control unit 13 serves as a data amount determining unit, a starting command converting unit, and an on-demand transmission control unit by means of the printer driver when data of the JPEG file F is printed by the printer 2.

The data amount determining unit compares a data size written in a frame header or the like of the printing target file F with a storage capacity (for example, 3 MB or 5 MB) of a receiving and storing memory 22 of the printer 2, which is received from the printer 2, and determines whether data of the printing target file F exceeds the storage capacity of the receiving and storing memory 22.

The starting command converting unit converts a file transmission starting command to be transmitted to the printer 2 from a batch transmission starting command (transmission starting command in a normal mode) to an on-demand transmission starting command (transmission starting command in an on-demand mode) before data transmission when the data of the printing target file F exceeds the storage capacity of the receiving and storing memory 22. The printer 2 is operated by a predetermined printer control command (specifically, ESC/P command), and the batch transmission starting command or the on-demand transmission starting command is an example of the printer control command, respectively.

In the case that the data of the printing target file F exceeds the storage capacity of the receiving and storing memory 22, the on-demand transmission control unit transmits JPEG sub data files F1, F2, . . . , Fn−1 and Fn, which are formed by dividing the data of the printing target file F into data of a printing process unit amount of the printer 2, to the printer 2 through the USB terminal 11 of the communication unit 14, according to reception of a data requirement from the printer 2 after transmission of the on-demand transmission starting command. Herein, the data of the printing process unit amount of the printer 2 refers to data of a certain band amount (data amount required for printing of a height of about several tens of pixels) which is determined by the number of nozzles or the like of the printing head of the printer 2, and a data size thereof is set in advance.

The printer 2 has a PictBridge printing function of the photograph image of the digital camera and a printing function of a memory card as in the art, and also a printing function of a printing control program according to the invention (hereinafter, this printing function is referred to as a printing function according to the invention). To provide the printing function according to the invention, the printer 2 includes a communication unit 23 including the USB terminal 21, the receiving and storing memory 22, a printer control unit (printing job generating unit) 24 and a printing unit 25, and serves as a device apparatus for the host apparatus 1.

The receiving and storing memory 22 includes, for example, a 3 MB or 5 MB RAM, and stores data of JPEG files, etc. equal to or less than the storage capacity (3 MB or 5 MB), which are transmitted at one time to the communication unit 23 through the USB terminal 21 from the host apparatus 1 according to the data requirement of the printer 2 on the basis of the batch transmission starting command.

The printer control unit (printing job generating unit) 24 having such a microcomputer configuration stores the printing control program according to the invention, which is installed in the printer 2, and a PictBridge printing control program and a memory card printing control program or the like as in the related art in a ROM or RAM (not shown), and serves as a data requirement transmission control unit and a printing process control unit to be described below according to the printing control program of the invention.

The data requirement transmission control unit initially transmits a data requirement which is a kind of printing command, to the host apparatus 1 through the USB terminal 21 when the on-demand transmission starting command is received through the communication unit 23 from the host apparatus 1, and transmits a next data requirement to the host apparatus 1 through the USB terminal 21 every time when data of the sub data file F1 to Fn transmitted to the USB terminal 21 of the printer 2 from the host apparatus 1 is transmitted to the printing unit 25 and is printed.

Every time when the data of the sub data file F1 to Fn transmitted from the host apparatus 1 on the basis of the data requirement is received, the printing process control unit transmits the data of the received sub data file F1 to Fn to the printing unit 25, and controls a printing head and a paper feeding and ejecting mechanism of the printing unit 25 to print the data of the sub data file F1 to Fn onto a printing paper.

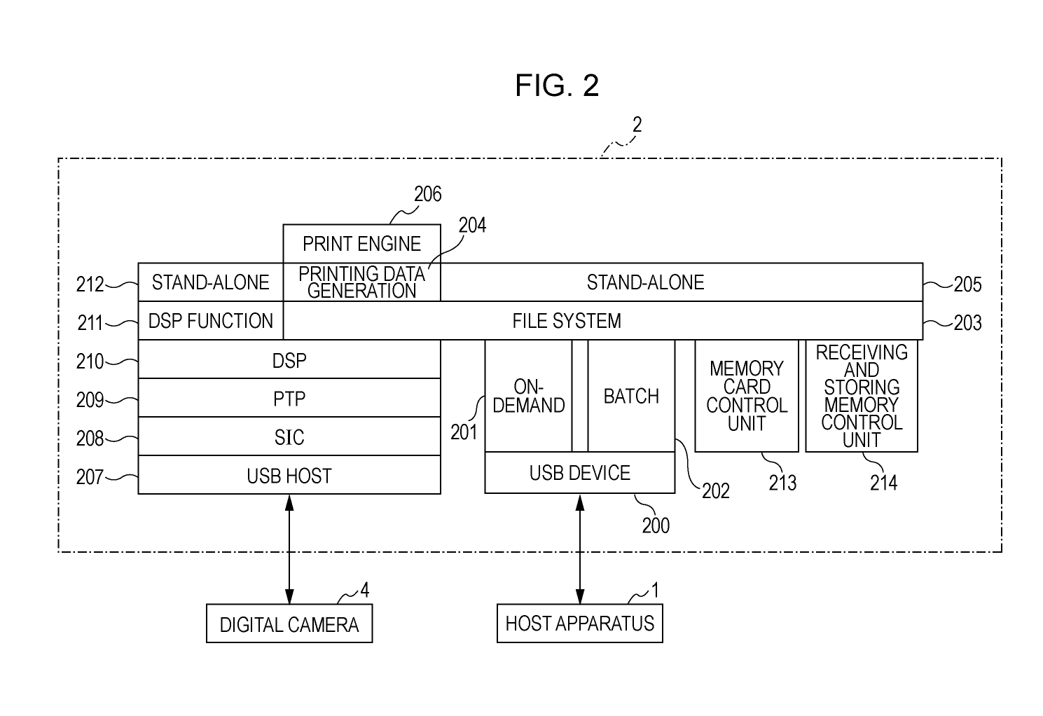

Further, a printing process control of the printer 2 may be illustrated with a hierarchical structure as shown in FIG. 2, on the basis of the above described each control program. In FIG. 2, a reference numeral 200 refers to a USB device layer connected to a USB host apparatus formed by the host apparatus 1 when the printer 2 operates as the device apparatus for the host apparatus 1; and a reference numeral 201 refers to a communication control layer of an on-demand printing control protocol provided above the USB device layer 200 and which receives the data of the sub printing file F1 to Fn. A reference numeral 202 refers to a communication control layer of a batch transmission printing control protocol and receives the data of the printing target file batch-transmitted from the host apparatus 1. A reference numeral 203 refers to a file system layer provided above the communication control layers 201 and 202 and which controls manipulation of a file such as a printing target file F or sub printing file F1 to Fn. A reference numeral 204 refers to a printing data generation layer provided above the file system layer 203 and which generates printing data of the printing unit 25 from the data of the printing target file F or the sub printing file F1 to Fn. A reference numeral 205 refers to a stand-alone printing control layer provided above the file system layer 203; and the reference numeral 206 refers to a print engine layer as the highest layer, which controls the printing unit 25 to perform printing. A reference numeral 4 refers to a digital camera which serves as a USB device apparatus, which is connected to the printer 2 which serves as the USB host apparatus in the case of the PictBridge printing; and a reference numeral 207 refers to a USB host layer connected to the digital camera 4. Reference numerals 208, 209 and 210 refer to respective communication control layers of an SIC (USB still image class), a PTP (Picture Transfer Protocol) and a DSP (Display PostScript) provided above the USB host layer 207. Above the communication control layer 210 are provided the file system layer 203 and a DSP function layer 211; and above the DSP function layer 211 is provided a stand-alone printing control layer 212. In addition, below the file system layer 203 are provided a control layer 213 of a memory card such as Compact Flash (registered trademark) or an SD card, and a control layer 214 of the receiving and storing memory 22. Reading and writing of data in the memory card (not shown) and the receiving and storing memory 22 are controlled by the control layers 213 and 214.

Further, the receiving and storing memory 22 is commonly used as a temporary storage area for data in all types of printings including the PictBridge printing and the memory card printing. For example, in the PictBridge printing and the memory card printing, in the case that long horizontal image data of the JPEG file is printed, since the image is rotated by 90 degrees and then is printed onto a printing paper, it is necessary to make a reading access order of the JPEG file different from a writing access order (recording order) thereof. However, if such a modification of the file access is performed in the digital camera 4 or a device apparatus of the memory card which is a physical device, a processing speed becomes decreased. Thus, in the PictBridge printing and the memory card printing, image data of the received JPEG file is temporarily stored in the receiving and storing memory 22, the reading file access is made to be different from the writing file access, and image data of the image which is rotated by 90 degrees is read from the receiving and storing memory 22 for printing, by the printer 2 which serves as the host apparatus, thereby achieving a high speed process. Meanwhile, in the printing of the printing function according to the invention, the receiving and storing memory 22 is used for storing the data of the JPEG file transmitted at one time from the host apparatus 1 according to the data requirement of the printer 2 on the basis of the batch transmission starting command. In this respect, since it is impossible to receive and store a JPEG file having a data size which exceeds the storage capacity of the receiving and storing memory 22 in the receiving and storing memory 22, the JPEG file is divided into the sub files F1 to Fn and is printed in an on-demand manner without using the receiving and storing memory 22.

Hereinafter, in the case that a printing target file is a JPEG file of an image, a process order of the host apparatus 1 and the printer 2 will be described.

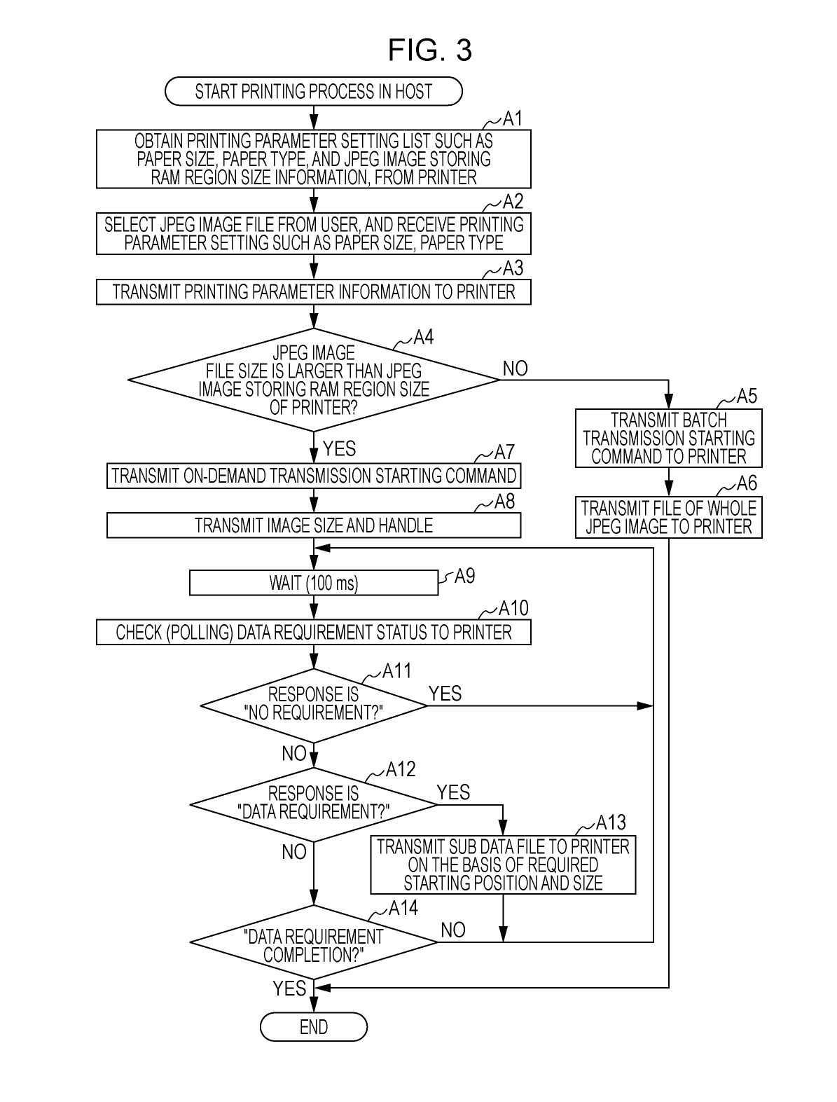

FIG. 3 is a flowchart illustrating a process in the host apparatus 1. Firstly, the host apparatus 1 receives printing parameter setting list information such as a paper size, a paper type, and information on the storage capacity (RAM region size for JPEG image storage) of the receiving and storing memory 22 from the printer 2, and displays an image of a selection target and a printing setting menu such as a paper size, paper type on a display screen through a user interface (step A1). Then, the host apparatus 1 receives user's image selection and setting of printing parameters including a paper size, paper type, etc., and determines a JPEG file of a printing target and printing parameters thereof (step A2), Then, information on the printing parameters is transmitted to the printer 2 (step A3). Thereafter, it is determined whether a data size of the JPEG file of the printing target exceeds the size of the JPEG image storing RAM region (step A4). If the data size of the JPEG file of the printing target does not exceed the size of the JPEG image storing RAM region, a file batch transmission starting command is transmitted through “NO” in step A4 (step A5), and a data requirement is received from the printer 2 and all the data of the JPEG file of the printing target is transmitted at one time (step A6), thereby terminating the process. Meanwhile, if the data size of the JPEG file of the printing target exceeds the size of the JPEG image storing RAM region, a transmission starting command is converted into an on-demand transmission starting command, and the on-demand transmission starting command is transmitted, through “YES” in step A4 (step A7), and further, an image size and an image handle are transmitted (step A8). Then, after waiting for a response time of, for example, 100 ms (step A9), a status of the data requirement is polled to the printer 2 for checking (step A10). Then, if the received data requirement command is “no requirement”, the process goes back to step A9 through “YES” in step A11. If the data requirement command is “data requirement”, the process passes through “NO” in step A11 and “YES” in step A12. Herein, data of the sub data file (JPEG file) obtained by dividing the data of the JPEG file of the printing target is transmitted according to a required starting position and the data size (step A13), and then, the process goes back to step A9. Every time when a data requirement command of a “during data requirement” is received, the data of the sub data file is sequentially transmitted. If the data of all the sub data files is transmitted, the data requirement command becomes “data requirement completion”. The process is terminated through “NO” in step A12 and “YES” in step A14.

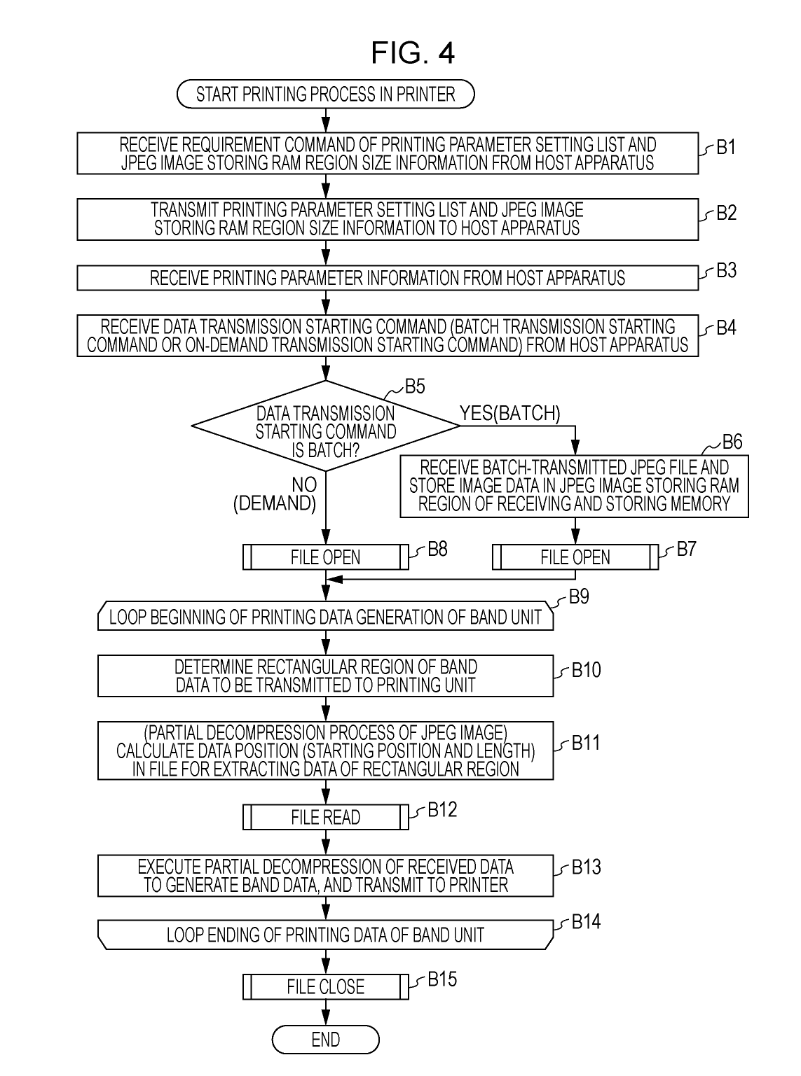

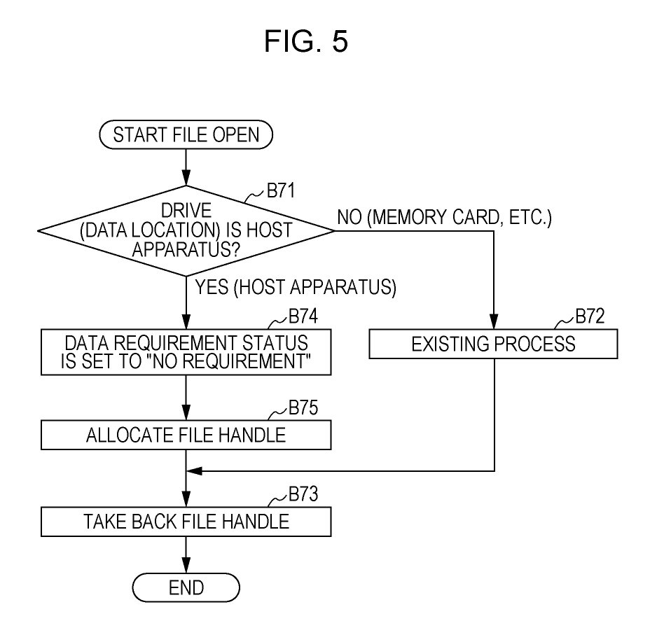

FIG. 4 is a flowchart illustrating a process in the printer 2. The printer 2 firstly receives a requirement command of the printing parameter setting list information and the size information of the JPEG image storing RAM region (step B1), and transmits the information to the host apparatus 1 (step B2), and then receives the printing parameter information and a data transmission starting command (batch transmission starting command or on-demand transmission command) from the host apparatus 1 (steps B3 and B4). In this respect, when the printer 2 receives the batch transmission starting command, the entire data of the JPEG file received at a time according to transmission of the data requirement of “data requirement” is stored in the receiving and storing memory 22 (step B6), and then a file open process is executed in step B7. In such a process, as shown in FIG. 5, a location (drive) of the file is confirmed (step B71). In the case of a file in a memory card, etc. (not shown), a corresponding existing process is executed through “NO” in step B71 (step B72), and the file handle is taken back (step B73), and then, the process is terminated. Meanwhile, in the case of a file in the host apparatus 1, the data requirement is set to “no requirement” through “YES” in step B71 (step B74), and the file handle is allocated to the received file (step B75). Then, the file handle is taken back (step B73), and then, the process is terminated. Further, when the on-demand transmission starting command is received, every time when the data of the sub data file is received according to transmission of the data requirement of “data requirement”, a file open process as described above is executed without storing in the storing memory 22 (step B8).

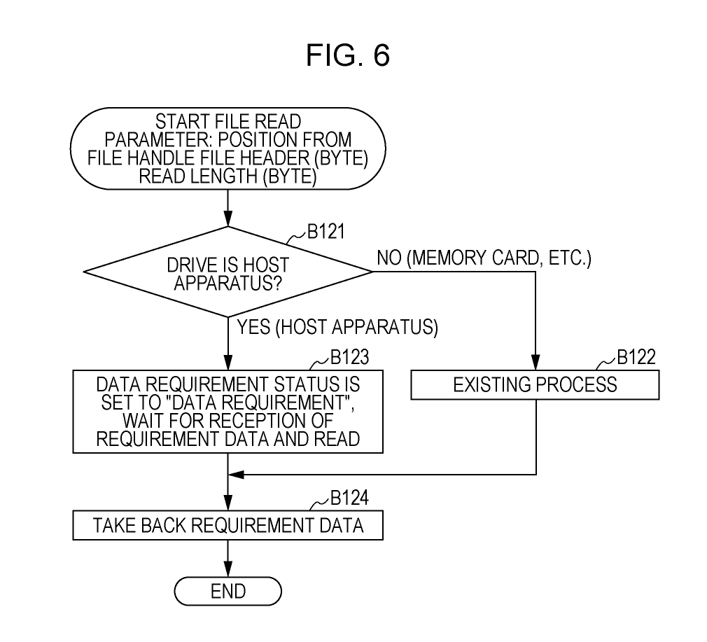

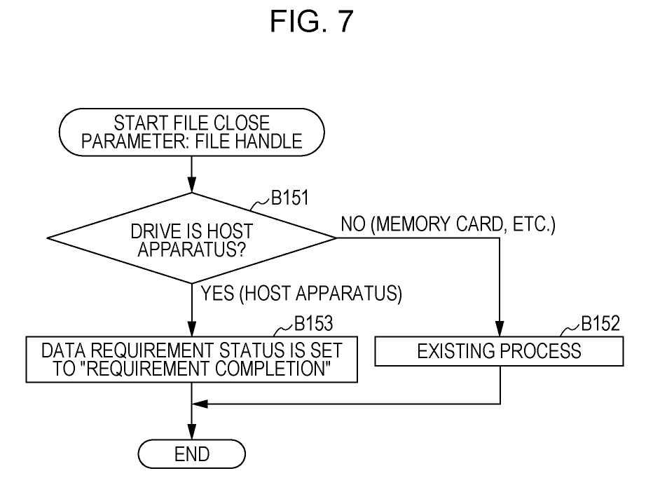

Next, a loop process of printing data generation in steps B9 to B14 is executed for a file designated by the file handle in step B7 or step B8, and if all printing data is generated and printing is terminated, a file close process (step B15) is executed, and then, the process is terminated. In step B9, the printing processing loop begins; in step B10, a rectangular region (having a height of several tens of pixels) of band data (data of the printing process unit amount) to be transmitted to the printing unit 25 is determined; in step B11, a partial decompression (decoding) process is performed for the JPEG file, and a data position (starting position and length) in a file required for extracting the rectangular region obtained in step B10, is obtained. In step B12, a file read process is performed, and parameters such as a position (several bytes) from the file handle and file header and a reading length (bytes) are obtained. In step B13, the received JPEG data is partially decompressed on the basis of the parameters, and the band data (printing data) is generated and transmitted to the printing unit 25 for printing. In step B14, the printing loop process is terminated. Further, the file read process in step B12 includes steps B121 to B123 as shown in FIG. 6. Firstly, it is determined whether the file is received from the host apparatus 1 on the basis of the file handle (step B121). If the file is received from a device other than the host apparatus 1, a corresponding existing file read process is performed (step B122); and if the file is received from the host apparatus 1, a status of a data requirement is set to “data requirement”, a position and a length from a header is set to parameters, and reception of the required data is waited for (step B123). Then, the received data is taken back (step B124). The file close process in step B15 includes steps B151 to B153 as shown in FIG. 7. Firstly, it is determined whether the file is received from the host apparatus 1 on the basis of the file handle (step B151). If the file is received from a device other than the host apparatus 1, a corresponding existing file close process is performed (step B152); and if the file is received from the host apparatus 1, the status of the data requirement is set to “requirement completion”.

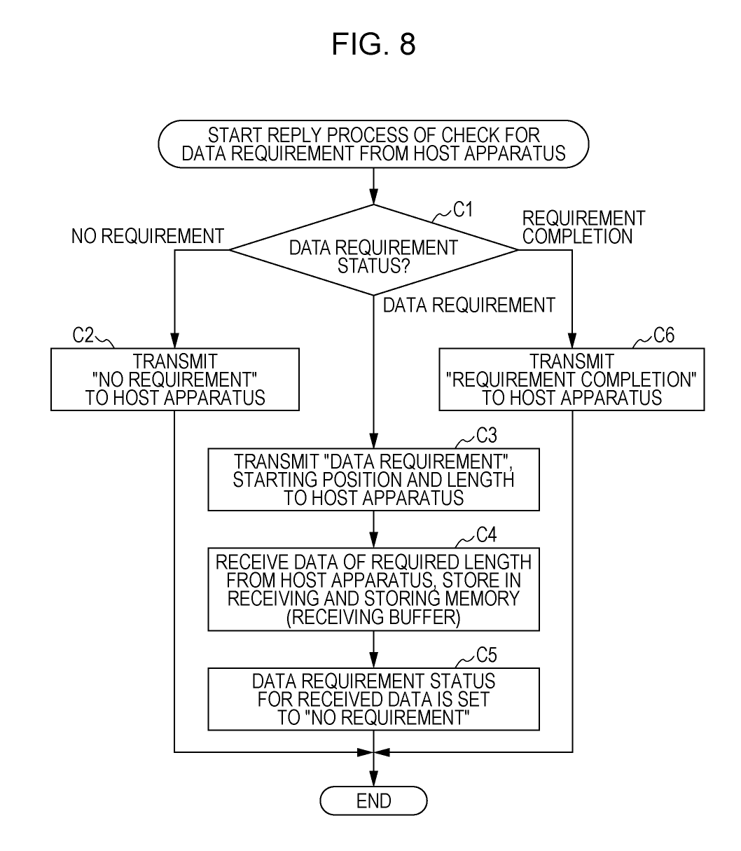

FIG. 8 illustrates a response process for a data requirement of the printer 2. Firstly, the status of a current data requirement is determined on the basis of polling from the host apparatus 1 (step C1). While the received data is, for example, being printed, “no requirement” is transmitted to the host apparatus 1 (step C2). When data is required, “data requirement” and a beginning position and a length are transmitted (step C3). Then, data of the length is received from the host apparatus 1, and if the data is batch-transmitted, the received data is stored in the receiving and storing memory 22 (step C4). In either case of the batch transmission or the on-demand transmission, if the reception of the data is completed, the status is set to “no requirement” (step C5). If the data requirement is completed, “requirement completion” is transmitted to the host apparatus 1 (step C6).

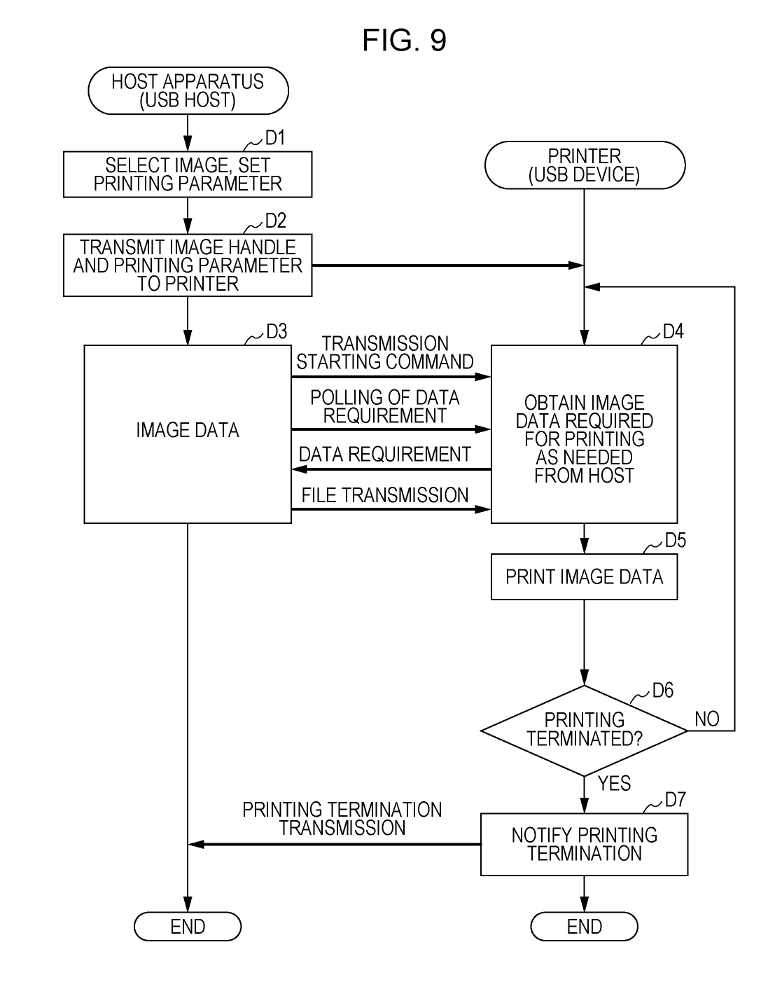

Thus, in the case of the present embodiment, if the data of the printing target file is data of a JPEG file having a data size exceeding the storage capacity of the receiving and storing memory 22 of the printer 2, a sub data file of data divided into a unit amount which is capable of being printed by the printer 2 is transmitted to the printer 2 from the host apparatus 1, and thus, it is possible to perform printing without receiving and storing all of the data in the receiving and storing memory 22. FIG. 9 schematically illustrates a relation of the processes and communication between the host apparatus 1 and the printer 2. In the host apparatus 1, if image data of a JPEG file as a printing target is selected by a selecting manipulation, etc. For an image displayed on a screen, and a variety of parameters (printing parameters) of the selected image is set by a setting manipulation, etc. For printing conditions of a printing menu displayed on a screen (step D1), the host apparatus 1 transmits the printing parameters of the selected image to the printer 2 (step D2). Then, according to polling of a data requirement based on an on-demand transmission starting command, the host apparatus 1 receives the data requirement and sequentially transmits sub data files F1 to Fn of a JPEG file F of the selected image to the printer 2 (step D3). Every time when data of the sub data files F1 to Fn is received (step D4), the printer 2 sequentially prints the data of the sub data files in the printing unit 25 (step D5). If the printing is completed, printing completion is notified to the host apparatus 1 from the printer 2, and then, the process is terminated (steps D6 and D7). In FIG. 9, thick arrows refer to the communication.

The invention is not limited to the above described embodiments, but a variety of modifications may be made without departing from the spirit of the invention. For example, data of a printing target file is not limited to data of a JPEG file, but may be image file data having a variety of data formats. Further, the host apparatus 1 may be a variety of computer devices, and the printer 2 may be a printer other than an ink jet printer. Furthermore, the host apparatus 1 and the printer 2 may have configurations and processing orders different from those of the above described embodiments.

In addition, the invention may be applied to a variety of printing systems having a configuration in which a printer as a device apparatus is connected to a host apparatus, a printer driver of the host apparatus and a printing program of the printer.

What is claimed is:

1. A printing system including: a host apparatus; and a printer as a device apparatus which is connected to the host apparatus,
wherein the host apparatus comprises:
a data amount determining unit which determines whether data of a printing target file exceeds a storage capacity of a receiving and storing memory of the printer when the data of the printing target file is transmitted to the printer and printed on the basis of a data requirement of the printer;
a starting command converting unit which converts a file transmission starting command to be transmitted to the printer, from a batch transmission starting command to an on-demand transmission starting command, when the data of the printing target file exceeds the storage capacity of the receiving and storing memory of the printer; and
an on-demand transmission control unit which transmits a sub data file, which is formed by dividing the data of the printing target file into data of a printing process unit amount of the printer, to the printer according to reception of the data requirement from the printer after transmission of the on-demand transmission starting command; and
wherein the printer comprises:
a data requirement transmission control unit which initially transmits the data requirement to the host apparatus according to reception of the on-demand transmission starting command and transmits a next data requirement every time when data of the sub data file, which is formed by dividing the data of the printing target file into the data of the printing process unit amount and is transmitted from the host apparatus, is printed; and
a printing process control unit which controls a printing process for the data of the received sub data file every time when the sub data file transmitted from the host apparatus is received on the basis of the data requirement.

2. A printer which is connected to a host apparatus, comprising:
a data requirement transmission control unit which initially transmits a data requirement to the host apparatus according to reception of an on-demand transmission starting command and transmits a next data requirement every time when data of a sub data file, which is formed by dividing data of a printing target file into data of a printing process unit amount and is transmitted from the host apparatus, is printed; and
a printing process control unit which controls a printing process for the data of the received sub data file every time when the sub data file transmitted from the host apparatus is received on the basis of the data requirement.

3. A host apparatus comprising:
a data amount determining unit which determines whether data of a printing target file exceeds a storage capacity of a receiving and storing memory of a printer as a device apparatus which is connected to the host apparatus when data of the printing target file is transmitted to the printer and printed on the basis of a data requirement of the printer;
a starting command converting unit which converts a file transmission starting command to be transmitted to the printer from a batch transmission starting command to an on-demand transmission starting command when the data of the printing target file exceeds the storage capacity of the receiving and storing memory of the printer; and
an on-demand transmission control unit which transmits a sub data file, which is formed by dividing the data of the printing target file into data of a printing process unit amount of the printer, to the printer according to reception of the data requirement from the printer after transmission of the on-demand transmission starting command.
